(19) United States
(12) Patent Application Publication
(10) Pub. No.: US 2023/0081297 A1
(43) Pub. Date: Mar. 16, 2023

(54) ZERO-GRAVITY MASSAGE FOLDING CHAIR

(71) Applicant: NECTAR INTERNATIONAL CO.,LTD., Nanjing City (CN)

(72) Inventor: Meidi Chen, Nanjing City (CN)

(21) Appl. No.: 17/695,676

(22) Filed: Mar. 15, 2022

(30) Foreign Application Priority Data
Sep. 14, 2021 (CN) 2021222278895

(51) Int. Cl. A61G 15/00; A47C 4/28; A61H 7/00; A61G 15/12

(52) U.S. Cl. CPC A61G 15/007; A47C 4/28; A61H 7/007; A61G 15/002; A61G 15/12; A61H 2201/0149; A61H 2201/5025

(57) ABSTRACT

The present application provides a zero-gravity massage folding chair, which relates to the technical field of health care equipment. The zero-gravity massage folding chair comprises a chair body and a face fabric provided on the chair body, wherein the chair body is provided with a plurality of massagers, the massagers are provided on the face fabric, the chair body is unfolded when in use, the massagers provided on the chair body massage corresponding parts of the human body, and the chair body is folded when not in use. The zero-gravity chair of the present application can choose to massage in different scenes according to actual needs, such as in parks or at home, thus overcoming the defect that the traditional space capsule massage chair cannot move according to actual situations.

### TECHNICAL FIELD

The present application relates to the technical field of health care equipment, in particular to a zero-gravity massage folding chair.

### BACKGROUND

The “zero-gravity” massage chair is designed according to the principle of a space capsule seat of National Aeronautics and Space Administration (NASA). When an astronaut rests on the space capsule seat, his back and thigh usually form 128 degrees (with an error of ±7 degrees), while his thigh and shank form 133 degrees (with an error of ±8 degrees), and his knee is slightly higher than his heart. At this time, gravity is evenly distributed throughout the body and keeps the human spine in an S-shaped curve. This sitting posture helps to relax the spine, relieve muscle tension and promote human blood circulation. People apply the principle of the space capsule seat to a massage chair through simulation technology, so as to realize a completely relaxed, natural and comfortable massage posture.

Traditional massage chairs are generally space capsule massage chairs, which have the function of “zero-gravity” and can be found everywhere in some public places such as shopping malls. The space capsule massage chairs are heavy, which can only be fixed at a certain position and cannot be moved anywhere according to the needs of users, resulting in the defect of limited use.

### SUMMARY

In view of this, the purpose of the present application is to provide a zero-gravity massage folding chair, in order to solve the technical problem in the prior art that the space capsule massage chair can only be fixed at a certain position due to its heavy weight and results in the limited use.

In order to achieve the above purpose, the present application provides a zero-gravity massage folding chair, comprising a chair body and a face fabric provided on the chair body, wherein the chair body is provided with a plurality of massagers, the massagers are provided on the face fabric, the chair body is unfolded when in use, the massagers provided on the chair body massage corresponding parts of the human body, and the chair body is folded when not in use.

According to a preferred embodiment, the chair body comprises a backrest, a seat, leg rests and a support frame, the backrest and the leg rests are provided on both sides of the seat and are foldably connected with the seat, and the support frame is provided below the seat and is foldably connected with the seat.

According to a preferred embodiment, a first massager is provided above the backrest at the shoulder, and a second massager is provided below the backrest at the waist.

According to a preferred embodiment, the first massager and/or the second massager is a single-head massager and/or a double-head massager and/or a multi-head massager.

According to a preferred embodiment, the face fabric is provided with an installation sleeve, the installation sleeve is provided with sewing threads, and the sewing threads divide the installation sleeve into a plurality of accommodation areas.

According to a preferred embodiment, the single-head massager, the double-head massager or the multi-head massager all comprise a plug, a wire and a massage head, the wire is connected with the plug and the massage head at the same time, a control switch is provided on the wire, and the massage head is placed in the accommodation area.

According to a preferred embodiment, the first massager and/or the second massager is provided as a kneading massager.

According to a preferred embodiment, a third massager is provided at the legs of the leg rests.

According to a preferred embodiment, the third massager is a single-head massager, a double-head massager or a multi-head massager.

According to a preferred embodiment, the third massager is a kneading massager.

The zero-gravity massage folding chair provided by the present application has the following technical effects.

The zero-gravity massage folding chair adds massaging and folding functions on the basis of the zero-gravity chair, specifically comprising a chair body and a face fabric provided on the chair body. The chair body is provided with a plurality of massagers. The massagers are provided on the face fabric. The chair body is unfolded when in use. People lie on the face fabric, and the massagers provided on the chair body massage corresponding parts of the human body. The chair body is folded when not in use, and it is portable without occupying space. That is, the zero-gravity chair of the present application can choose to massage in different scenes according to actual needs, such as in parks or at home, thus overcoming the defect that the traditional space capsule massage chair cannot move according to actual situations.

### BRIEF DESCRIPTION OF THE DRAWINGS

In order to explain the embodiments of the present application or the technical scheme in the prior art more clearly, the drawings used in the embodiments or the description of the prior art will be briefly introduced hereinafter. Obviously, the drawings in the following description are only part of the embodiments of the present application. For those skilled in the art, other drawings can be obtained according to these drawings without paying creative labor.

FIG. 1 is a use state diagram of a zero-gravity massage folding chair according to an embodiment of the present application.

FIG. 2 is a schematic structural diagram of a partial face fabric of a zero-gravity massage folding chair in FIG. 1.

FIG. 3 is a schematic structural diagram of a double-head massager of a zero-gravity massage folding chair in FIG. 1.

FIG. 4 is a schematic structural diagram of a kneading massager of a zero-gravity massage folding chair in FIG. 1.

In FIG. 1 to FIG. 4:
1. Chair body; 11. Backrest; 12. Seat; 13. Leg rest; 14. Support frame;
2. Face fabric; 21. Installation sleeve; 21. Sewing thread; 22. Accommodation area;
31. First massager; 32. Second massager; 33. Third massager; 34. Double-headed massager; 31. Massage head; 32. Wire; 33. Plug; 34. Control switch; 35. Kneading massager.

### DETAILED DESCRIPTION OF THE EMBODIMENTS

In order to make the purpose, technical scheme and advantages of the present application clearer, the technical scheme of the present application will be described in detail hereinafter. Obviously, the described embodiments are only part of the embodiments of the present application, rather than all of the embodiments. Based on the embodiments in the present application, all other embodiments obtained by those skilled in the art without paying creative labor belong to the scope claimed by the present application.

In the description of the present application, it should be noted that, unless otherwise specified, “a plurality of” means two or more; the orientation or position relationship indicated by the terms “upper”, “lower”, “left”, “right”, “inner”, “outer”, “front end”, “back end”, “head” and “tail” is based on the orientation or position relationship shown in the drawings, which is only for convenience of describing the present application and simplifying the description, but does not indicate or imply that the referred device or element must have a specific orientation, be constructed and operated in a specific orientation, so that it cannot be understood as limiting the present application. In addition, the terms “first”, “second”, “third”, etc. are only used for the purpose of description and cannot be understood as indicating or implying relative importance.

In the description of the present application, it should be noted that unless otherwise specified and defined, the terms “installation”, “linking” and “connection” should be understood in a broad sense, for example, they can be fixed connection, detachable connection or integrated connection; they can be mechanical connection or electrical connection; they can be direct connection or indirect connection through an intermediate medium. For those skilled in the art, the specific meanings of the above terms in the present application can be understood according to specific conditions.

As mentioned in the background art, the massage chairs in the prior art are generally space capsule massage chairs, which have the function of “zero-gravity” and can be found everywhere in some public places such as shopping malls. The space capsule massage chairs are heavy, which can only be fixed at a certain position and cannot be moved anywhere according to the needs of users, resulting in the defect of limited use.

Based on this, the present application provides a zero-gravity massage folding chair, which adds massaging and folding functions on the basis of the zero-gravity chair, specifically comprising a chair body and a face fabric provided on the chair body. The chair body is provided with a plurality of massagers. The massagers are provided on the face fabric. The chair body is unfolded when in use. People lie on the face fabric, and the massagers provided on the chair body massage corresponding parts of the human body. The chair body is folded when not in use, and it is portable without occupying space. That is, the zero-gravity chair of the present application can choose to massage in different scenes according to actual needs, such as in parks or at home, thus overcoming the defect that the traditional space capsule massage chair cannot move according to actual situations.

The technical scheme of the present application will be described in detail with reference to specific FIGS. 1-4 hereinafter.

The zero-gravity massage folding chair provided by the present application has a zero-gravity function, a massaging function and a folding function at the same time, which is specifically described as follows.

As shown in FIG. 1, the zero-gravity massage folding chair comprises a chair body 1 and a face fabric. The face fabric 2 is laid on the surface of the chair body 1 and the face fabric 2 can change with the shape of the chair body 1.

The chair body 1 is provided with a plurality of massagers, preferably three, namely a first massager 31, a second massager 32 and a third massager 33. Three installation sleeves 21 are provided on the corresponding face fabric 2. The installation sleeves 21 are located on the back side of the face fabric 2, and the front side of the face fabric 2 is used for people to lie down. The first massager 31, the second massager 32 and the third massager 33 are placed in the corresponding installation sleeves 21.

When in use, the chair body 1 is unfolded, the fabric 2 is correspondingly unfolded, the human body lies on the chair body 1, and the massager placed on the chair body 1 massages the corresponding parts of the human body. As the structure of the chair of the present application is a zero-gravity chair, massage is realized in a relaxed state. When not in use, the chair body 1 is folded, and it is portable without occupying space.

As shown in FIG. 1, the chair body 1 comprises a backrest 11, a seat 12, leg rests 13 and a support frame 14. The backrest 11 and the leg rests 13 are provided on both sides of the seat 12 and are foldably connected with the seat 12. The support frame 14 is provided below the seat 12 and foldably connected with the seat 12. It should be noted that the specific folding structure of the chair body 1 is not specifically limited in the present application. For example, it can be the folding structure in other forms. The structures, which can achieve the purpose of folding and has a zero-gravity function and a massaging function, are all within the protection scope of the present application.

Specifically, as shown in FIG. 1, a first massager 31 is provided above the backrest 11 at the shoulder, a second massager 32 is provided below the backrest 11 at the waist, and a third massager 33 is provided at the legs of the leg rests 13.

The first massager 31 can be a single-head massager, a double-head massager, a multi-head massager or a kneading massager 35. Similarly, the second massager 32 can be a single-head massager, a double-head massager, a multi-head massager or a kneading massager 35. The third massager 33 can be a single-head massager, a double-head massager, a multi-head massager or a kneading massager 35. The present application does not limit the type of massagers. The massagers, which can achieve the massage effect and is installed on a zero-gravity folding chair, are all within the protection scope of the present application.

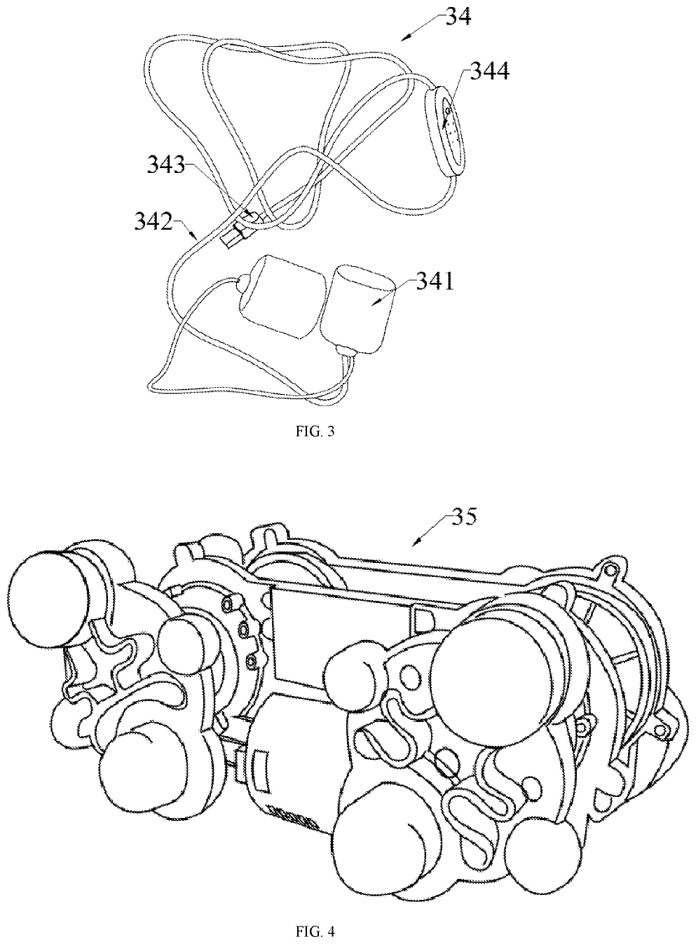

As shown in FIG. 3, the double-head massager 34 comprises a plug 343, a wire 342 and two massage heads 341. The two massage heads 341 are arranged side by side. The wire 342 is connected with the plug 343 and the two massage heads 341 at the same time. A control switch 344 for controlling to turn on/off the double-head massager 34 is provided on the wire 342.

FIG. 4 is a schematic structural diagram of the kneading massager 35.

Further, installation sleeves 21 are provided on the back side of the face fabric 2. There three installation sleeves, the number of which is the same as that of the massagers, also includes three. The installation sleeves are used for accommodating the first massager 31, the second massager 32 and the third massager 33.

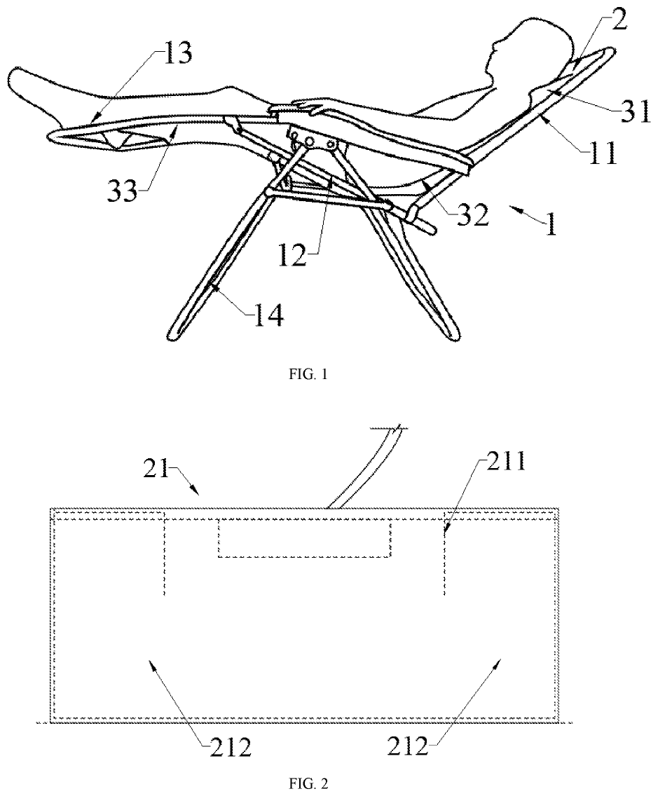

As shown in FIG. 2, the installation sleeve 21 is provided with sewing threads 211, and the sewing threads 211 divide the installation sleeve 21 into a plurality of accommodation areas 212. When a single-head massager or a double-head massager 34 is provided in the installation sleeve 21, the massage head 341 is placed in the accommodation areas 212.

When the human body is lying down, the first massager 31, the second massager 32 and the third massager 33 are placed in the legs, waist and shoulder, the power is turned on, and the massage gear is adjusted by using a switch, so that the massage gear suitable for the human body can be selected, and the massage effect in a relaxed state can be achieved.

The above is only the specific embodiment of the present application, but the protection scope of the present application is not limited thereto. Any changes or substitutions conceivable to those skilled in the art within the technical scope disclosed by the present application should be covered within the protection scope of the present application. Therefore, the protection scope of the present application shall be subject to the protection scope of the claims.

What is claimed is:

1. A zero-gravity massage folding chair, comprising a chair body and a face fabric provided on the chair body, wherein the chair body is provided with a plurality of massagers, the massagers are provided on the face fabric, the chair body is unfolded when in use, the massagers provided on the chair body massage corresponding parts of the human body, and the chair body is folded when not in use.

2. The zero-gravity massage folding chair according to claim 1, wherein the chair body comprises a backrest, a seat, leg rests and a support frame, the backrest and the leg rests are provided on both sides of the seat and are foldably connected with the seat, and the support frame is provided below the seat and is foldably connected with the seat.

3. The zero-gravity massage folding chair according to claim 2, wherein a first massager is provided above the backrest at the shoulder, and a second massager is provided below the backrest at the waist.

4. The zero-gravity massage folding chair according to claim 3, wherein the first massager and/or the second massager is a single-head massager and/or a double-head massager and/or a multi-head massager.

5. The zero-gravity massage folding chair according to claim 4, wherein the face fabric is provided with an installation sleeve, the installation sleeve is provided with sewing threads, and the sewing threads divide the installation sleeve into a plurality of accommodation areas.

6. The zero-gravity massage folding chair according to claim 5, wherein the single-head massager, the double-head massager or the multi-head massager all comprise a plug, a wire and a massage head, the wire is connected with the plug and the massage head at the same time, a control switch is provided on the wire, and the massage head is placed in the accommodation area.

7. The zero-gravity massage folding chair according to claim 5, wherein the first massager and/or the second massager is provided as a kneading massager.

8. The zero-gravity massage folding chair according to claim 2, wherein a third massager is provided at the legs of the leg rests.

9. The zero-gravity massage folding chair according to claim 8, wherein the third massager is a single-head massager, a double-head massager or a multi-head massager.

10. The zero-gravity massage folding chair according to claim 8, wherein the third massager is a kneading massager.
